(19) United States
(12) Patent Application Publication
(10) Pub. No.: US 2011/0172074 A1
(43) Pub. Date: Jul. 14, 2011

(54) METHOD FOR CONTROLLING A CHOPPER FOLDER AND CHOPPER FOLDER

(75) Inventors: Thierry Vauchelle, Maignelay Montigny (FR); Franck Chagnon, Saint Leu D'Esserent (FR); Jerome Peres, Montataire (FR); Eric Pierda, Saint Leu D'Esserent (FR)

(73) Assignee: GOSS INTERNATIONAL MONTATAIRE SA, Montataire (FR)

(21) Appl. No.: 12/987,626

(22) Filed: Jan. 10, 2011

(30) Foreign Application Priority Data
Jan. 8, 2010 (FR) 10 50115

(51) Int. Cl. B31B 1/56

(52) U.S. Cl. 493/454

(57) ABSTRACT

A method adapted for a chopper folder, including a pair of parallel folding rollers defining between them an interstice, a mobile folding blade to force a flat product in the interstice, a means for adjusting the gap between the two folding rollers and a device for controlling the adjustment device. According to the method of the invention, at the beginning of a new production, the controller implements a production beginning mode, wherein it controls the means for adjusting the gap for the adjustment of the gap at a determined reference value, then a production mode, wherein it controls the means for adjusting for a gap adapted to the new production at a steady state.

This claims benefit of French Patent Application 10 50115, filed Jan. 8, 2010, and hereby incorporated by reference herein.

This invention relates to a to a method for controlling a chopper folder of a rotary press for the folding of flat products coming from a continuous strip.

### BACKGROUND

EP 2 112 111 discloses an apparatus and method for adjusting a gap between folding rollers to fold signatures in a printing press. The apparatus includes a gap adjusting mechanism, a detecting unit and a controller.

JP 7237812 discloses an inter roller gap adjusting device capable of shortening a change-over time according to the change of the thickness of a printing paper sheet and lightening the burden on the operator. The inter roller gap adjusting device consists of an adjusting mechanism which adjusts the gap between a pair of rollers and a drive means for driving the adjusting mechanism. A control means is also provided to control the drive means according to the relationship between the thickness of the printing sheet and a proper gap between the rollers for the thickness.

### SUMMARY OF THE INVENTION

An object of the invention is to provide a method for controlling a chopper folder making it possible to limit the risks of choking.

This invention provides a method for controlling a chopper folder of a rotary press for the folding of flat products coming from a continuous strip, comprising a pair of parallel folding rollers defining between them an interstice, a mobile folding blade to force a flat product in the interstice, a means for adjusting the gap between the two folding rollers and a device for controlling the adjustment device able to control the adjustment device in a production mode in order to maintain an adapted gap during a production.

The invention provides a method for controlling wherein at the beginning of a new production, the controlling device implements a production beginning mode wherein it controls the means for adjusting the gap for the adjustment of the gap at a determined reference value then the production mode, wherein it controls the means for adjusting for a gap adapted to the new production.

According to other embodiments, the method comprises one or several of the following characteristics, taken individually or according to all of the combinations that are technically possible:

the reference value is maintained during a determined duration, corresponding for example to the passage of approximately 200 flat products between the two folding rollers;

the reference value corresponds to a minimum gap;

the reference value corresponds to the gap of the previous production;

the reference value is smaller than the gap value of the new production;

the production beginning mode is implemented during a change in production and/or at the re-starting of the rotary press after a stoppage;

in the production mode, the controlling device controls the adjustment device as a function of a measurement of thickness of the continuous strip at the level of the nip rollers for the driving of the continuous strip;

in the production mode, the controlling device controls the adjustment device as a function of a measurement of pressure exerted on the continuous strip by nip rollers for the driving of the continuous strip;

in the production mode, the controlling device controls the adjustment device as a function of a measurement of thickness of the flat products at the level of the folding rollers;

in the production mode, the controlling device controls the adjustment device as a function of a measurement of pressure exerted on the flat products by the folding rollers; and

in the production mode, the controlling device controls the adjustment device as a function of a value of thickness of the flat product specified by an operator using a table wherein are pre-recorded values of thickness for different types of flat products.

The invention also provides a chopper folder of a rotary press for the folding of flat products, comprising a pair of parallel folding rollers defining between them an interstice, a mobile folding blade adapted to force a flat product in the interstice, an automated means for adjusting the gap adapted to adjust the gap between the two folding rollers as a function of a value of thickness of the flat product, and a device for controlling the adjustment device adapted and programmed to implement a method according to the invention.

### BRIEF DESCRIPTION FO THE DRAWINGS

The invention shall be better understood when reading the following description, provided only by way of example and made in reference to the annexed drawings, wherein:

FIG. 1 is a diagrammatical view of a folding machine of a rotary press;

FIG. 2 is a side diagrammatical view of a chopper folder of the folding machine of FIG. 1; and

FIG. 3 is a graph showing the gap between two folding rollers of the chopper folder as a function of time during the implementation of a method for controlling according to the invention.

### DETAILED DESCRIPTION

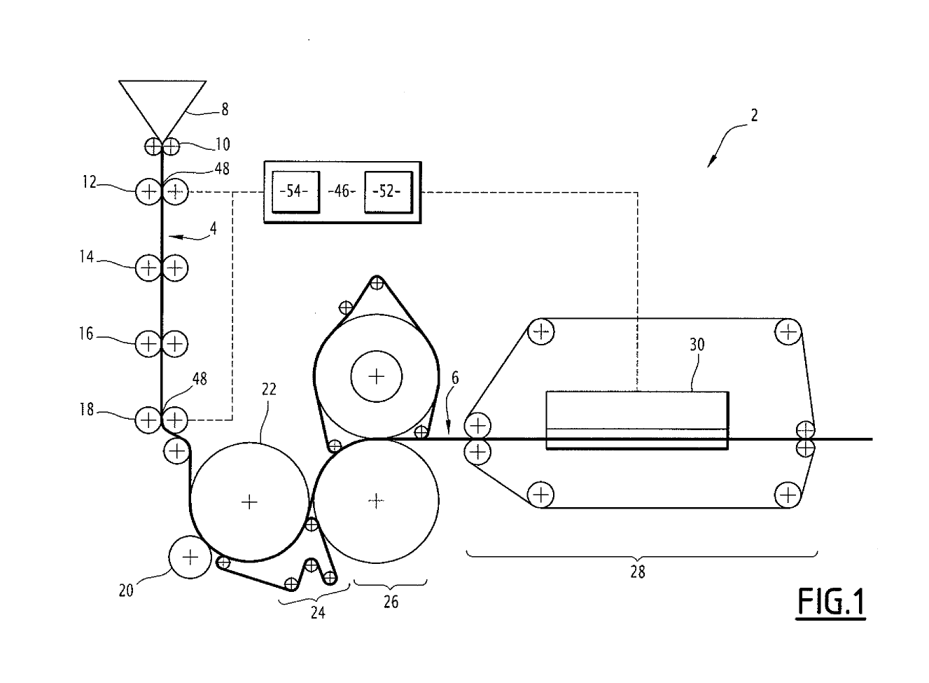

In FIG. 1 is a folding machine according to the invention, designated by the general reference 2. The folding machine 2 is adapted to receive a continuous strip of material, or several superimposed continuous strips of material, forming a continuous strip 4 of flat products 6, to fold the continuous strip 4, and to separate and fold the flat products 6.

The folding machine 2 is part of a printing press, rotative in particular, not shown as a whole in FIG. 1. The elements of the folding machine 2 shall be described in the order wherein the continuous strip 4 of flat products 6 travels along this folding machine 2.

The folding machine 2 comprises a cone 8, or former, for longitudinal folding with two gripper rollers 10 adapted to create a first fold, a longitudinal fold, of the continuous strip 4 of flat products 6. The folding machine 2 comprises motorised nip rollers arranged downstream of the cone 8 to drive the continuous strip 4 by maintaining it under tension.

A first pair of nip rollers 12 is located immediately downstream of the gripper rollers 10 and controls the tension and the draw of the continuous strip 4 on the cone 8.

The folding machine 2 can include a pair of transversal perforation rollers 14 and a pair of longitudinal perforation rollers 16. The transversal perforation rollers 14 facilitate the formation of a second fold, a transversal fold, and the longitudinal perforation rollers 16 facilitate the formation of a third fold, a right-angle fold. The perforation rollers 14, 16 can be activated or deactivated according to the type of production to be carried out.

A second pair of nip rollers 18 located downstream of the perforation rollers 14, 16 controls the tension and the draw of the continuous strip 4 of the level of the perforation rollers 14, 16.

The folding machine 2 comprises a cutting cylinder 20 provided with a saw frame and adapted to cut the continuous strip 4 transversally and separate it into a succession of separated flat products 6. The flat products 6 are then driven by a transfer cylinder 22 together with a set of cylinder bearers 24 which carry them towards a set of folding cylinders 26 which carries out the second fold, the transversal fold.

Downstream of the set of folding cylinders 26, the folding machine 2 comprises a chopper folder 28. This chopper folder 28 is adapted to carry out a right-angle fold of the flat product 6.

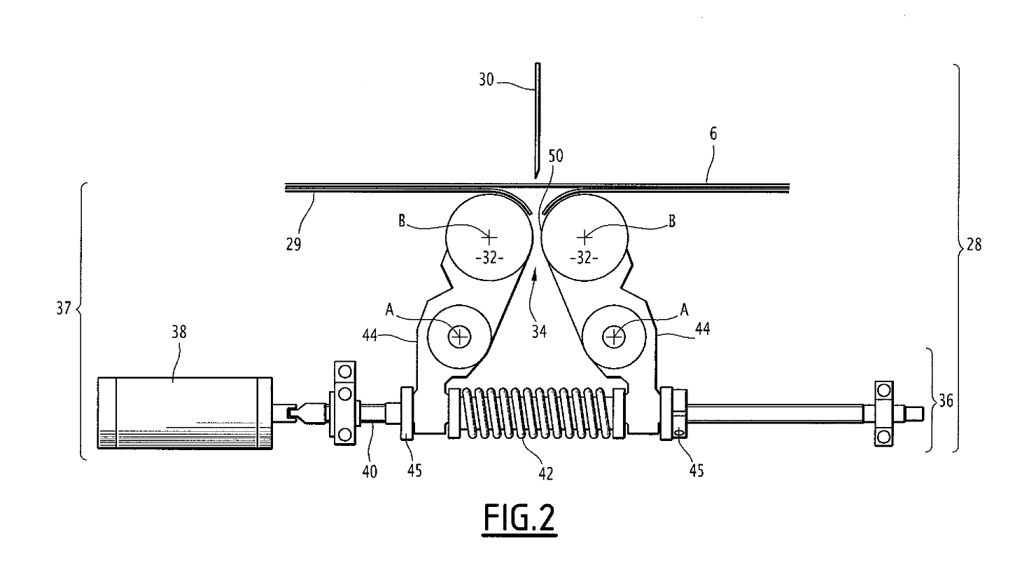

The chopper folder 28 is shown in more detail in FIG. 2. It comprises a table 29 for receiving flat products 6 provided with a slot, a folding blade 30, a pair of parallel folding rollers 32 defining between them an interstice 34 facing the slot of the receiving table 29 and an adjustment device 36.

The folding blade 30 is mobile in alternate translation through the slot of the receiving table 29, to force flat products 6 received on the receiving table 29 through the slot and in the interstice 34 between the two folding rollers 32. The folding rollers 32 are motorised to drive the flat product 6 between them. The folding blade 30 and the folding rollers 32 cooperate to form the right-angle fold.

The adjustment device 36 is used to modify the gap between the folding rollers 32. It comprises two setting units 37 each arranged at one end of the folding rollers 32. In FIG. 2, only one setting unit 37 is visible and shall be described in what follows. The other setting unit 37 is analogous and the setting units 37 are synchronised.

The setting unit 37 shown in FIG. 2 comprises a motor 38, a screw 40, a spring 42 and a pair of rotating arms 44.

The arms 44 are mounted rotatingly around parallel respective axes A.

Each folding roller 32 is mounted rotatingly at one end of a respective arm 44, around an axis B parallel to the rotation axis A of the arm 44. The rotation of the arms 44 causes a modification of the gap between the folding rollers 32.

The spring 42 is arranged between the ends of the arms 44 opposite the folding rollers 32 and solicits them in the direction of the folding rollers 32 coming together.

The screw 40 is provided with nuts 45 serving as a stop in rotation for the arms 44 in the direction of the folding rollers 32 coming together. The spring 42 solicits the arms 44 as a stop against the nuts 45.

The position of the nuts 45 defines the gap between the folding rollers 32. The rotation of the screw 40 modifies the gap between the nuts 45 and therefore the adjustment of the gap between the folding rollers 32. The rotation of the screw 40 also modifies the compression of the spring 42.

The motor 38 is coupled to the screw 40 in such a way that the motor 38 can drive the screw 40 in order to modify the position of the nuts 45 and therefore the adjustment of the gap between the folding rollers 32.

During operation, the folding blade 30 forces the flat product 6 between the motorised folding rollers 32 which drive the flat product 6 between them forming a right-angle fold. The passage of the flat product 6 between the folding rollers 32 is carried out against the spring 42 which opposes the gap of the folding rollers 32. The pressure exerted by the folding rollers 32 therefore depends on the adjustment of their separation.

The folding machine 2 further comprises a controller 46 adapted to control the adjustment device 36. This controller 46 comprises a first pressure sensor 48 at the level of the first pair of nip rollers 12 and/or at the level of the second pair of nip rollers 18, a second pressure sensor 50 at the level of the folding rollers 32, a processor 52 and a man-machine interface 54.

The first and second pressure sensors 48, 50 are adapted to measure the pressure applied on the continuous strip 4 by the first and/or second pair of nip rollers 12, 18 and on the flat product 6 by the folding rollers 32, respectively. The processor 52 is programmed to control and regulate the adjustment device 36 on the basis of the measurements taken. The man-machine interface 54 makes it possible for a user to specify manual control instructions to the controller 46.

The operation of the folding machine 2, and in particular a method for controlling the folding machine 2, are described hereinbelow.

In the folding machine 2, the continuous strip 4 is folded longitudinally at the level of cone 8, is then perforated and cut into a plurality of flat products 6 which are folded transversally with respect to the first fold. The flat products 6 then pass in the chopper folder 28 where they are folded a third time according to a line parallel to the first fold.

A slight modification of the thickness of the continuous strip 4 at the level of the cone 8 results in a modification of the thickness that is four times higher at the level of the folding rollers 32 of the chopper folder 28. It is desirable to be able to adjust the interstice 34 between the two folding rollers 32 as a function of the thickness of the continuous strip 4 in order to prevent a choking of the chopper folder 28 at the level of the folding rollers 32, for example due to a gap that is too large that does not allow the folding rollers 32 to absorb correctly the flat products 6 engaged between the folding rollers 32 by the folding blade 30.

To this effect, the folding machine 2 implements a method for controlling which is driven by the controller for 46. According to this method for controlling, the controller 46 controls the adjustment device 36 selectively in a production beginning mode and in a production mode.

The production mode is implemented in a steady or permanent state of production.

In the production mode, the first and second pressure sensors 48, 50 measure the pressure applied on the continuous strip 4 exerted by the first and/or second pair of nip rollers 12, 18 and on the flat product 6 exerted by the folding rollers 32, respectively. The values of pressure measured are transmitted to the processor 52 which determines a value of thickness of the continuous strip 4 at the level of the first and/or second pair of nip rollers 12, 18 and the gap between the two folding rollers 32. The processor 52 determines if the gap between the two folding rollers 32 is big or small with respect to the thickness of the continuous strip 4 at the level of the first and/or second pair of nip rollers 12, 18 and controls the adjustment device 36 in such a way that the gap between the two folding rollers 32 is adjusted as a function of the thickness of the continuous strip 4 at the level of the first and/or second pair of nip rollers 12, 18. The production mode makes it possible to regulate in an automated manner the gap between the two folding rollers 32 without human intervention and is adapted for a continuous operation of the folding machine 2.

Alternatively, the controller 46 does not take pressure measurements, but a user chooses, for example in a table of pre-recorded values of thickness, the value of thickness of the corresponding flat product 6, by means of the man-machine interface 54. The controller 46 controls the adjustment device 36 in such a way that the gap between the two folding rollers 32 is adjusted as a function of the value of thickness specified by the user.

The production beginning mode is implemented at a transient state at the beginning of each new production.

A production is defined in particular by the quality of paper (format, grammage, thickness) and by the treatment of the continuous strip 4 and of the flat product 6 (number of superimposed strips, number and positions of the folds, accumulated and non-accumulated production, number of pages, etc.). The modification of a production parameter modifies the characteristics of the flat products 6 at the level of the chopper folder 28.

“New production” means a production starting after a change in production resulting from a modification of the production parameters or the carrying out of a splice, or the re-starting of a production after a stoppage of the rotary press, for example after a strip breakage.

At the beginning of a new production, the controller 46 is configured in order to maintain between the folding rollers 32, in production mode, a gap adapted to the new production, due to the fact that it receives the information relative to the new production and/or the measurements for the adjustment of this gap taken on the continuous strip 4 corresponding to the new production which starts to circulate in the folding machine 2.

According to the invention, in the production beginning mode, the controller 46 controls the gap of the folding rollers 32 at a determined fixed reference value.

The two folding rollers 32 take a position determined with a reference gap independently from a measurement of pressure exerted by the nip rollers 12, 18 or from a value of gap specified manually for the second production.

The production beginning mode is maintained for a determined duration. This duration is selected preferably in such a way that the production mode, which follows the production beginning mode, starts only when the first flat product 6 of the new production arrives or is passed at the level of the folding rollers 32. The duration typically corresponds to the passage time of about 200 flat products 6 at the level of the folding rollers 32.

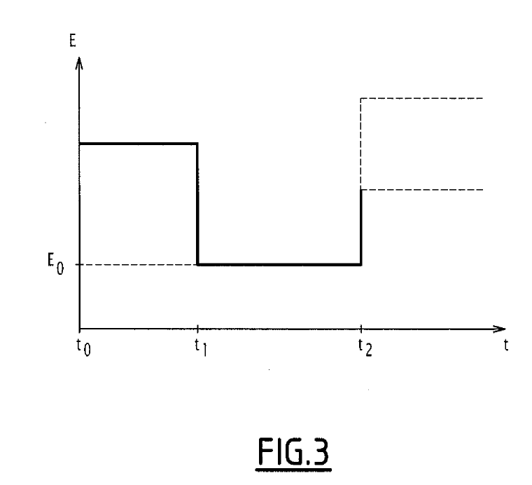

FIG. 3 shows the gap between the two folding rollers 32 as a function of time. In the period between the instants t₀ and t₁ the folding machine 2 processes a first production. The gap between the two folding rollers 32 is adapted to the flat products 6 of this first production and the controller 46 is maintained in the production mode. At the instant t₁, production is changed and we move to a second production, and between the instant t₁ and the instant t₂ the controller 46 is maintained in the production beginning mode. The gap corresponds to the reference gap E₀. After the instant t₂, the controller 46 resumes the production mode and the gap is adjusted to the thickness of the flat product 6 of the second production. The thickness of the flat product 6 is determined either by the measurement of pressure, or manually by means of the man-machine interface 54.

The reference gap is selected to allow the chopper folder 28 to absorb the flat products 6 of the production preceding the new production, despite the processing changes (number of pages, thickness, accumulated or non-accumulated production).

The reference gap can be smaller than the gap required for the second production. The reference gap for the second production can be the gap of the first production.

In an alternative, the reference gap is a minimum gap for the folding rollers 32, corresponding to the minimum gap adjustment between the folding rollers 32. This minimum gap is for example approximately 0.1 mm.

In another alternative, the reference gap is not limited to a single value of reference gap, but several values of reference gap can be considered. During the production beginning mode, the value of reference gap is adopted which is, among the various values of reference gap, the best adapted to the value of thickness of the flat product 6 of the production processed during the period directly before this period of production beginning mode.

The method for controlling according to the invention is particularly advantageous in the cases where the flat products 6 of the new production have a thickness greater than that of the flat products 6 of the previous production, in such a way that the remainder of flat products 6 intended for the previous production may not be correctly absorbed between the folding rollers 32.

The method for controlling according to the invention is particularly advantageous:

when passing from a non-accumulated production to an accumulated production,

when passing from a production with paper of low grammage to a production with paper of high grammage or

After a breakage of the continuous strip 4, in particular during the passage of the splice, i.e. of the part where two pieces of continuous strips 4 are joined, in the chopper folder 28.

What is claimed is:

1. A method for controlling a chopper folder of a rotary press for the folding of flat products coming from a continuous strip, comprising a pair of parallel folding rollers defining between them an interstice, a mobile folding blade for forcing a flat product in the interstice, an adjustment device for adjusting the gap between the pair of parallel folding rollers and a controller for controlling the adjustment device, the controller controlling the adjustment device in a production mode in order to maintain an adapted gap during a production, wherein, at the beginning of a new production, the controller implements a production beginning mode wherein the controller controls the adjustment device at a determined reference value and then implements the production mode, wherein the controller controls the adjustment device for a separation adapted to the new production.

2. The method for controlling according to claim 1 wherein the determined reference value is maintained during a determined duration.

3. The method for controlling according to claim 1 wherein the determined reference value corresponds to a minimum gap.

4. The method for controlling according to claim 1 wherein the determined reference value corresponds to the gap of a previous production.

5. The method for controlling according to claim 1 wherein the determined reference value is smaller than a gap value of the new production.

6. The method for controlling according to claim 1 wherein the production beginning mode is implemented during a change in production and/or at a re-starting of the rotary press after a stoppage.

7. The method for controlling according to claim 1 wherein in the production mode, the controller controls the adjustment device as a function of a measurement of thickness of the continuous strip at a level of nip rollers for driving the continuous strip.

8. The method for controlling according to claim 1 wherein in the production mode, the controller controls the adjustment device as a function of a measurement of pressure exerted on the continuous strip by nip rollers for driving the continuous strip.

9. The method for controlling according to claim 1 wherein in the production mode, the controller controls the adjustment device as a function of a measurement of thickness of the flat products at a level of the pair of parallel folding rollers.

10. The method for controlling according to claim 1 wherein in the production mode, the controller controls the adjustment device as a function of a measurement of pressure exerted on the flat products by the pair of parallel folding rollers.

11. The method for controlling according to claim 1 wherein in the production mode, the controller controls the adjustment device as a function of a value of thickness of the flat product specified by an operator using a table of pre-recorded values of thickness for various types of flat products.

12. A chopper folder of a rotary press for the folding of flat products, comprising a pair of parallel folding rollers defining between them an interstice, a mobile folding blade adapted to force a flat product in the interstice, an automated adjustment device for adjusting the gap between the pair of parallel folding rollers as a function of a value of thickness of the flat product, and a controller for controlling the adjustment device, the controller being adapted and programmed to implement the method according to claim 1.

13. The method according to claim 2 wherein the determined duration is for the passage of 200 flat products between the pair of parallel folding rollers.
